(19) United States
(12) Patent Application Publication
(10) Pub. No.: US 2005/0284303 A1
(43) Pub. Date: Dec. 29, 2005

(54) Portable brewing system

(76) Inventors: Bill Zell, Bozeman, MT (US); Stuart M. Levit, Bozeman, MT (US)

Correspondence Address: Stuart M. Levit, P.O. Box 544, Bozeman, MT, 59771, US

(21) Appl. No.: 11/157,285

(22) Filed: Jun. 21, 2005

Related U.S. Application Data
(60) Provisional application No. 60/582,466, filed on Jun. 23, 2004.

(51) Int. Cl. A47J 31/00

(52) U.S. Cl. 99/279

(57) ABSTRACT

A “closed/sealed” portable brewing system with a housing, a cover, and a filter, in which the housing has an opening with external threads having a first axis of rotation, the cover has internal threads with a second axis of rotation opposite from the first axis of rotation, and the filter is fixedly attached between the cover and the opening of the housing.

### CROSS REFERENCE TO RELATED APPLICATION

Priority is claimed from U.S. Provisional Application No. 60/582,466, entitled “Portable Brewing System”, filed Jun. 24, 2004, by the same inventors, which is incorporated herein by reference in its entirety.

### BACKGROUND AND SUMMARY OF THE INVENTION

The present invention relates generally to a portable brewing system, and more particularly to, a portable coffee, tea, or beverage (collectively referred to herein as “coffee”) brewing system.

Portable coffee makers for use in back country settings such as trekking, backpacking, and hiking are known. For example, portable percolators brew for a large number of people, but they are heavy and bulky. Other coffee makers such as the coffee Bodum, GSI Lexan JavaPress for the backcountry traveler is also bulky and functionally limited. Further, most of the existing outdoor coffee makers are made from non-recyclable products, which is not conducive to maintaining a clean environment.

In the absence of having a portable coffee maker, outdoors recreationists have been known to make “cowboy coffee” (i.e., where coffee grounds are poured directly into a container of hot water and allowed to settle before drinking). One improvement to cowboy coffee making (although not intended as such) has been developed by Eva Solo called the CafeSolo™ coffee maker, which consists of four parts: a flask for holding water and the coffee beans, a filter funnel, a tip-up lid which automatically opens when coffee is poured, and a neoprene cover which keeps coffee hot.

However, none of these known coffee brewing systems absent traditional cowboy coffee may readily be used without specialized and cumbersome equipment. Disclosed herein are different embodiments of a brewing system that address these and other problems by advantageously being limited in weight, easy to use, recyclable, durable, suitable for outdoor use, portable, and small in size. Moreover, the embodiments of the brewing system are advantageously multifunctional (i.e., is adapted for different uses and makes use of existing containers): utilizing, for example, an existing water bottle for brewing coffee in the morning, tea in the evening, and for water during in the day. A further advantage is that the filter of the brewing system may be used to make coffee and/or to strain detritus from water (as, for example, a pretreatment such as to extend a micropore water filter's usable life, or to remove detritus when micropore treatment is not employed).

Yet another advantage of the filter of the brewing system is that it may also be used to make cold beverages. As an example, iced coffee or tea may be made by placing water, cold water, or water and ice in the container, and coffee grounds or tea leaves into the filter. With the container lid replaced, the cold water would interact with the grounds or leaves and “cold brew” a beverage. This is not unlike “sun tea” or similar iced beverages.

The brewing system may, for example, be used by backcountry/outdoor users, business/office/construction/manufacturing workers, and general recreationists. More generally, the brewing system is adapted for use by any user who desires or needs some form of “personal hydration”, ranging from bottled elixirs to bottled water to soda pop. Many people carry containers for hydration, including examples such as Nalgene® or Coleman® containers to hold water or other beverages. Advantageously, any user who has already purchased a reusable container, such as a Nalgene® or Coleman® container can benefit from the brewing system's adaptable use with such existing containers to brew, store, and/or drink beverages of any temperature (i.e., hot, warm, or cold) with/from such containers.

The embodiments of the brewing system and method allow beverages to be brewed in a closed (e.g., water-tight, leak-proof, and/or spill-proof) setting. That is, the beverage may be brewed and the brewing container may be turned in any direction, knocked-over, shaken, etc., without leaking or spilling. In one embodiment, shaking is a desirable method of brewing beverages using the system. Advantageously, the system is adapted to brewing beverages in a mobile setting, such as backpacking, bicycling, walking, driving a vehicle, etc.

In accordance with one embodiment, there is disclosed a portable brewing system adapted to be used with a housing that includes a cover, a mesh filter, and an insulator for the housing, allowing the user to brew a beverage in a closed system, thereby procuring different beverages with minimal equipment, weight, and effort, and further allowing brewing to occur while moving while minimizing or eliminating the likelihood of spills and/or leakage.

In accordance with various embodiments of the portable brewing system, the opening of the housing is one of circular, conical, oval, or similar shape; the filter is stainless steel, plastic, rubber, paper, or similar material or a combination thereof, or a fabric-like single or multiple use mesh; the filter is conical, cylindrical, square, or a combination thereof; the mesh filter has a cap of its own that is held in a fixed position between the top of the mesh filter and the cover of the housing, and sealing to the filter's rim, keeping brewing ingredients from soiling the housing's cover.

In other embodiments, the system includes an insulator to shield/encase the housing, protect the user from heated liquids in the housing, and which may include a holding mechanism to immobilize the housing's cover when not sealed to the housing, and which may also include a handle or other mechanism to allow the housing to be held and used like a mug or pitcher. In yet other embodiments, a separate sealable container/vessel to hold the filter unit and attaching to the housing, insulator, housing-cover retainer, or other part of the system. In yet a further embodiment, a platform holds the filter unit above any beverage container so that the filter unit may be used for drip-through brewing with almost any housing or beverage container.

### BRIEF DESCRIPTION OF THE DRAWINGS

These and other aspects of the invention will become apparent from the following description which illustrates preferred and alternative embodiments of the invention read in conjunction with the accompanying drawings wherein the same reference numerals have been applied to like parts and in which:

FIGS. 1-4 illustrate a first embodiment of the portable brewing system.

FIGS. 1-2 are schematic drawings showing how the parts of the portable brewing system fit together.

FIG. 3 is a side view of the filter, rim, and filter cover.

FIG. 4 is an enlarged view, from an angle, of the filter and rim.

FIG. 5 is a cross section showing the holder.

FIGS. 6-9 illustrate a second embodiment of the portable brewing system.

FIG. 6 illustrates the filter removably attached to a bracket that is manufactured with the lid or attached to an existing lid.

FIG. 7 illustrates a bracket that holds the filter and is attached to the holder's rim by a removable device (such as suction cup, screw, etc.).

FIG. 8a is a detailed drawing detailing a holder lid manufactured with an assembly/bracket onto/into which the filter removably attaches (related to FIG. 6).

FIG. 8b illustrates a combined holder lid with attached filter, and secondary lid covering the opening used to access the filter.

FIG. 9 illustrates an embodiment where the filter wedges into the rim of the holder.

FIG. 10 illustrates a third embodiment in which the filter is a separate removable unit that attaches onto the top of the bolder. The holder's cover may be used on the filter, or another cover may attach to the top of the filter or holder, or the bottom of the filter.

### DETAILED DESCRIPTION

A. First Embodiment

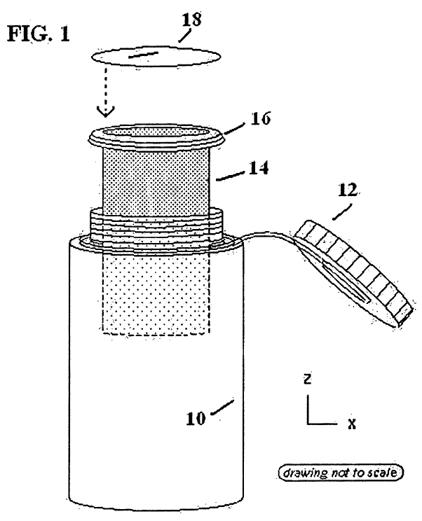

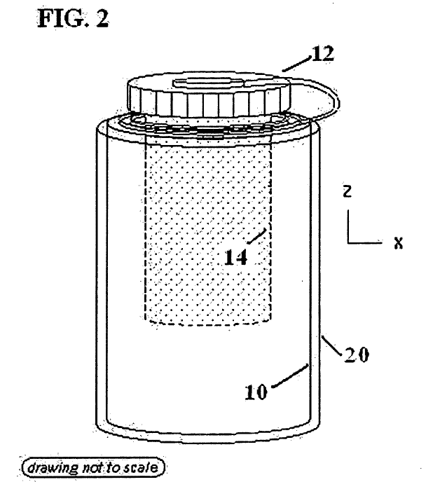

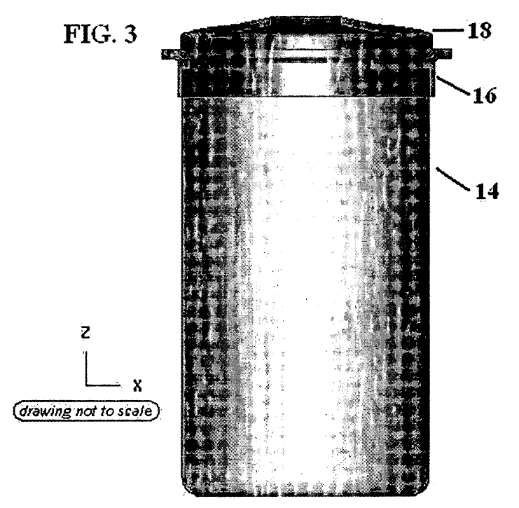

FIGS. 1-4 illustrate a first embodiment of a portable brewing system. In the FIGS. 1-4, the portable brewing system 2 includes: (a) container 10 (i.e., housing, flask, glass, mug, or bottle, all used interchangeably herein to refer to container 10); (b) housing cover or lid 12; (c) cylindrical mesh filter 14 with lip 16 (or in alternate embodiments, the filter 14 may have other shapes such as a conical or oval in shape, or any combination thereof); (d) filter cap 18; (e) housing insulator 20.

The container 10 has an opening with external threads that have a first axis of rotation. The cover 12 of the container 10 has internal threads with a second axis of rotation opposite from the first axis of rotation of the opening of the housing. In this way, the container 10 with cap 18 may be securely sealed. Alternatively, the seal may be made using a snap or other lid. The cover 12, or its embodiments, may have a separate opening such that, when it is sealed to the housing, the user may drink or pour the beverage from the housing through the opening (not shown). The cover's opening could be closed with a seal, snap, or similar mechanism that when the cover is affixed to the housing and the opening is closed, the housing is sealed. Alternatively, the cover 12 or filter 14 may also incorporate a press mechanism, similar to a “French press”, that allows the filter to operate as a French press and still maintain its seal (not shown).

The filter 14 sits on the edge of the opening to the housing 10. The lip 16 allows the filter 14 to remain suspended from the container with a small gap between the inner opening of the container and the filter. This allows the filter 14 to easily enter in and out of the container 10 and be sealed at the lip 16 when the container 10 and cap 18 are securely sealed.

In addition, if desired, to maximize the convective surface area, the entire surface area of the filter 14 may be made of a mesh such as stainless steel, or resilient durable plastic or rubber or similar material or combination thereof. These materials are flexible and to some degree can bounce back after being crushed or bent, thereby allowing the filter 14 of the brewing system to still function even if it is crushed or bent. Stainless steel mesh is, advantageously, tear-resistant unlike a plastic mesh but it will be appreciated by those skilled in the art that a combination of materials may provide the most durability and resilience.

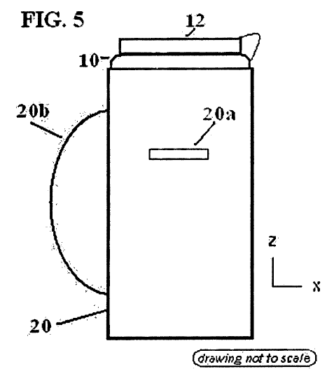

The housing insulator 20 may be made of a material such as neoprene to insulate hot and cold liquids in the container 10 and protect the user's hands when handling the container 10 when it is full of hot or cold liquid. The housing insulator is generally illustrated in FIG. 5 and is made of an insulating waterproof material, such as neoprene. This “skirt” may include an apparatus 20A to hold open the cover 12 when that is attached to the housing 10, such that the apparatus immobilizes the cover 12 against the side of the housing so that the cover does not interfere with pouring, brewing, drinking, etc. The “skirt” may include a handle 20B that allows the housing to be used as a “mug” or pitcher. The lid holder 20A and handle 20B may be permanently attached to or removable from the skirt 20. The housing 20 may or may not cover the bottom of the housing. The housing insulator 20 may be common to all embodiments of the portable brewing system.

In operation, brewing ingredients 15 (e.g., coffee or tea) are placed inside the filter 14 and optionally covered with filter cap 18 to keep cover/lid 12 clean; and then cover/lid 12 may be placed onto the housing to seal the unit. Depending on the brewing ingredients a fluid 13 may be placed in the container 10 either before or after inserting the filter 14. The brewing ingredients 15 (e.g., water) maybe made to remain in contact with the fluid 13 in the container 10 with the lid 12 closed until brewing is completed.

When the user decides that the ingredients have had sufficient time to brew, the filter 14 is removed from the container 10. The filter 14 may be stored away in its carrying case or sack (not shown) before or after the brewing ingredients are removed and/or the filter is rinsed clean. Alternatively, a user may also use a “disc” (not shown) to hold the filter unit and brew a beverage by the traditional drip method into any housing, cup, or container placed under and/or supporting the disc.

Advantageously, the filter 14 of the brewing system is portable and has the following features: (a) small, lightweight (e.g., 2-4 ounces) and operates with existing housings (e.g., water bottles) and thereby provides little additional weight to a backpack or carried bag; (b) durable and recyclable as it is manufactured with stainless steel, presumably recyclable plastics, or ideally other recyclable materials; (c) adapted to brew other drinks in addition to coffee such as tea and infusions; (d) minimal additional “stuff” to own, carry, or operate in order to make beverages; (e) adaptable with its platform disc (not shown) to allow the filter unit, when placed in/on the disc, to operate on almost any housing or container to brew a beverage (more like the traditional drip-coffee method).

In one embodiment, the filter may be inserted in a water bottle (e.g., such as a Nalgene® bottle). Consequently, for back country travelers who want to minimize the weight they must carry and/or the bulk/space of their loads, a water bottle can be used, for example, to brew coffee, tea or any hot drink in the morning and then can be converted back to its original use as a water bottle during the day.

A manual or automatic pressure valve may be built into the system, such as in the filter, rim, holder, holder's lid, or filter's cover, to allow for pressure changes in air and liquid. This may be incorporated into all embodiments.

B. Second Embodiment

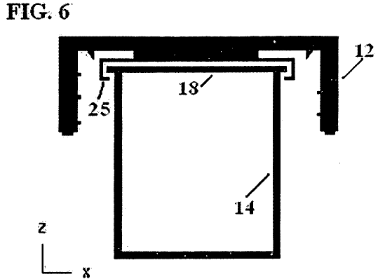

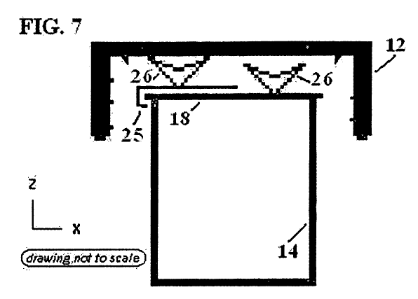

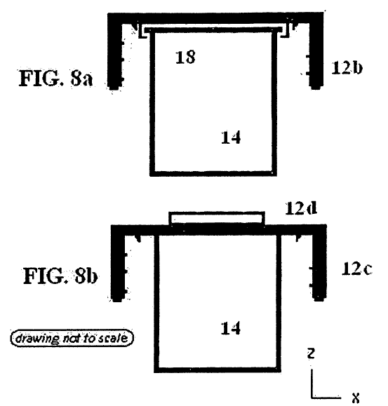

FIGS. 6-9 illustrate a second embodiment of the brewing system. In this embodiment, the filter is removably attached to a bracket that is fixedly attached to the housing's existing cover 12 (FIGS. 6 and 7), or the filter is attached to a permanent bracket that is manufactured onto a lid that fits the housing (FIGS. 8a and 8b), or the filter is held by friction against the inside surface of the neck of holder 10.

The FIGS. 6-9 illustrate some of the variations of this second embodiment of a portable brewing and include a bracket to hold the filter.

In FIG. 6, a bracket 25 holds filter 14 (e.g., may be manufactured with) the cover 12 such that the bracket is a permanent component part of cover 12.

In FIG. 7, the bracket may be a separate item that is attached to the cover 12 temporarily (removable). As shown in FIG. 7, the filter attaches to the bracket and is removable from the bracket. Examples of possible means of temporarily attaching the bracket to the cover 12 include but are not limited to glue, double-side sticky foam/tape, other adhesive material, suction cups, or screw, with the screw mounted to the lid and the bracket twisting onto the screw. When the cover 12 is placed on the holder 10 the filter, being attached to the cover 12, remains suspended from the cover 12 within the housing 10.

FIGS. 8a and 8b further illustrate a lid with the filter attached to cover 12C, and a separate opening and lid 12D built into this cover 12C. The filter chamber is accessed via lid 12D, which may be interchangeable with the housing's original cover 12.

Alternatively, the cover 12 or filter 14 may also incorporate a press mechanism, similar to a “French press”, that allows the filter to operate as a French press and still maintain its seal (not shown).

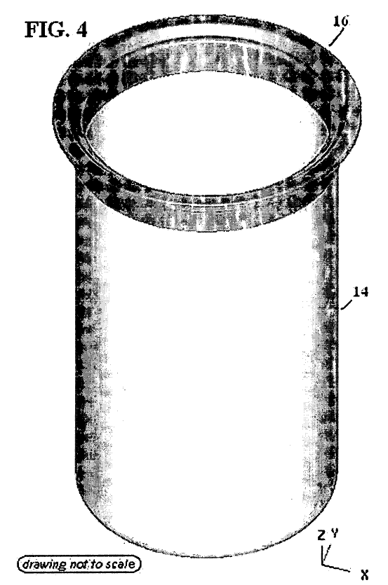

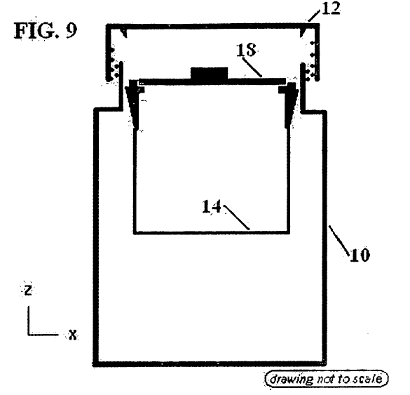

FIG. 9 illustrates an alternative of the second embodiment of the brewing system. In this embodiment, the filter is held in the housing by being wedged into the neck the housing. As illustrated in FIG. 4, this embodiment includes a filter 14 with a rim of its own that fits and seals to the housing 10's neck/rim. The filter thus is supported by, and sealed to, the housing by the filter's rim pressing against the housing's neck/rim, and is removable from the housing. The housing may be sealed, with the cover 12 fitting onto the housing 10 (the filter would not add to or interfere with the operation of the cover 12).

Alternatively, the cover 12 or filter 14 may also incorporate a press mechanism, similar to a “French press”, that allows the filter to operate as a French press and still maintain its seal (not shown).

C. Third Embodiment

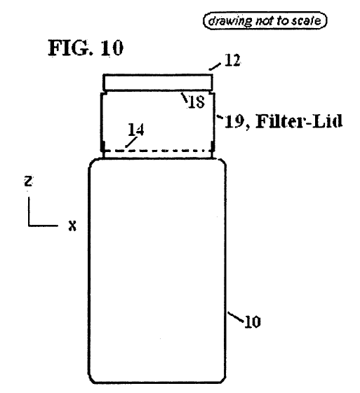

FIG. 10 illustrates a third embodiment of the brewing system. In this embodiment, the filter 14, which has a collar 19, is interposed between container 10 and the lid 12. In this embodiment, the filter may be fixedly attached on one side to the opening of the housing, or may rests upon the housing 10, and on the other side to the cover 12, providing a sealed/closed unit when the filter is in place and a normally sealed bottle when the filter is removed.

More specifically, this embodiment illustrated in FIG. 10 includes: (a) container 10 (i.e., housing, flask, glass, mug, or bottle, all used interchangeably herein to refer to container 10); (b) housing cover or lid 12; (c) filter 14, with collar 19, which attaches to and seals on its bottom with container 10 at container 10's threads, and includes a mesh or similar filter that is shaped conical, flat, or oval, or any combination thereof, and which is sealed from above by cover 12; (d) filter cap 18; and, optionally, and, optionally, (e) housing insulator. Filter-collar 19 has threads on its bottom matching the threads on cover 12 and threads on its top matching the threads on container 10. In this way, the container 10 with filter-collar 19, cap 18, and cover 12 may be securely sealed.

The portion of the filter-collar 10 (and/or lid), that appears outside of the container 10 when the container-filter-lid are coupled together in a closed position, may be smooth or contoured with flutes or grips or other shapes, textures, or materials, such as neoprene, that insulate the liquids in the filter-lid and protect the hands if the filter is hot. The filter-collar 19 may also have lids of its own (separate from the lid of the container 10) that screw onto the bottom and top such as to seal the lid closed when not in use. When these lids are comparable in size and shape, they will attach to either end of the filter.

Alternatively, the cover 12 or filter 19 may also incorporate a press mechanism, similar to a “French press”, that allows the filter to operate as a French press and still maintain its seal (not shown).

D. Miscellaneous

The invention has been described with reference to a particular embodiment. Modifications and alterations will occur to others upon reading and understanding this specification taken together with the drawings. The embodiments are but examples, and various alternatives, modifications, variations or improvements may be made by those skilled in the art from this teaching which are intended to be encompassed by the following claims.

1. A portable brewing system, comprising:
a housing having an opening with external threads having a first axis of rotation;
a cover having internal threads with a second axis of rotation opposite from the first axis of rotation of the opening of the housing; and
a filter unit for holding a brewing mixture; the filter unit having an opening with a lip that rests on the opening of the housing;
wherein the brewing mixture is sealed in the filter unit when the threads of the housing and the threads of the cover are rotated into a closed position.

2. The portable brewing system according to claim 1, wherein the opening of the housing is one of circular, conical, oval, or similar shape.

3. The portable brewing system according to claim 2, wherein the filter is stainless steel, plastic, rubber, paper, or similar material or a combination thereof.

4. The portable brewing system according to claim 2, wherein the filter unit is a single or multiple use mesh.

5. The portable brewing system according to claim 4, wherein the filter unit is conical, cylindrical, square, angular, or a combination thereof.

6. The portable brewing system according to claim 1, further comprising an insulator that encases the housing.

7. The portable brewing system according to claim 1, further comprising a separate sealable container for holding the filter unit and attaching the filter unit to the housing, insulator, housing-cover retainer, or other part of the system.

8. The portable brewing system according to claim 1, further comprising a platform for holding the filter unit at the opening of the housing when the lip of the filter unit fails to rest on the opening of the housing.

9. The portable brewing system according to claim 1, further comprising a cap fixedly interposed between the filter and the cover when the threads of the housing and the threads of the cover are rotated into a closed position.

10. The portable brewing system according to claim 9, wherein the cap comprises means for applying pressure between the lip of the filter and the cap when the threads of the housing and the threads of the cover are rotated into a closed position.

11. The portable brewing system according to claim 10, wherein the cap rests on a lip inside the opening of the filter unit.

12. The portable brewing system according to claim 1, wherein the lip of the filter unit communicates with the threads of the lip on a first side and the threads of the housing on a second side when the threads of the housing and the threads of the cover are rotated into a closed position.

13. The portable brewing system according to claim 1, wherein the lip of the filter unit wedges in the opening of the housing when the threads of the housing and the threads of the cover are rotated into a closed position.

14. The portable brewing system according to claim 13, wherein the lip of the filter grips against the opening of the housing.

15. A portable brewing system according to claim 1 wherein a French press unit is embodied into the filter and/or the housing and/or the housing's lid.

16. The portable brewing system according to claim 1, wherein the lip of the filter unit comprises a collar with a first side having threads that communicate with the threads of the housing and a second side having threads that communicate with the threads of the cover; wherein the lip of the filter unit is sealed when communicatively coupled in a closed position with the cap and the housing.

17. A portable brewing system, comprising:
a housing having an opening with external threads having a first axis of rotation;
a cover having internal threads with a second axis of rotation opposite from the first axis of rotation of the opening of the housing;
a bracket fixedly attached to the cover; and
a filter unit for holding a brewing mixture; the filter unit having an opening with a lip that attaches to the bracket;
wherein the brewing mixture is sealed in the housing when the threads of the housing and the threads of the cover are rotated into a closed position.

18. The portable brewing system according to claim 17, wherein the filter unit is fixedly attached to the cover using at least one suction cup.

19. The portable brewing system according to claim 17, wherein the bracket is integrally formed with the cover.

20. The portable brewing system according to claim 17, wherein the collar is collapsible into consecutively nested segments that when expanded form a vessel with a conical shape that includes filtering mesh at one end.

21. A portable brewing system, comprising:
a housing having an opening with external threads having a first axis of rotation;
a cover having internal threads with a second axis of rotation opposite from the first axis of rotation of the opening of the housing; and
a filter unit for holding a brewing mixture; the filter unit having an opening with a lip that rests on the opening of the housing;
wherein the lip of the mesh filter wedges into the housing's rim, allowing the housing's cover to seal the brewing mixture when the threads of the housing and cover are rotated into a closed position.
